(19) United States
(12) Patent Application Publication
(10) Pub. No.: US 2007/0140827 A1
(43) Pub. Date: Jun. 21, 2007

(54) Power operated stair

(76) Inventors: Milton Blanchard, Memphis, TN (US); Linda J. Blanchard, Memphis, TN (US)

Correspondence Address: Charles F. Rye, Fifth Floor, 8 South Third Street, Memphis, TN, 38103, US

(21) Appl. No.: 11/311,545

(22) Filed: Dec. 19, 2005

(51) Int. Cl. B62D 55/00; B65F 9/00; B65G 67/00

(52) U.S. Cl. 414/809; 180/9.22

(57) ABSTRACT

A power operated stair. The stair assembly extends and retracts by powered means generally by conversion of electrical energy to mechanical motion. The basic stair section includes an aperture cover, rotational hinging means, additional stair sections, means for transmitting mechanical power and a power unit. The power stair may further include power features which will unfold or extend the additional stair sections. The power unit may operate on different type energy sources. The means for transmitting mechanical power may be electro-mechanical or electro-hydraulic and may include means for receiving external mechanical operation in case of power/system failure. The power stair may be operated by a wall mounted control and/or remote control and either of these controls may further include security features. The wall mounted control includes a convenient structure power disconnect to receive external alternate power.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, etc

NOT APPLICABLE

### BACKGROUND OF THE INVENTION

This invention relates to power retractable stairs. In its most common embodiment this invention would replace foldable pull-down attic stairs. Ceiling height, strength of the person operating the common spring loaded stairs, aesthetics and safety/security are addressed by this invention.

As housing trends turned toward single level structures there developed a need for temporary access to the attic portion which was generally relegated to storage. Retractable “pull-down” stairs have long been known as access to attics and other areas that are accessed on a limited basis. A major attractive feature of retractable stairs is space saving of the lower floor. A fixed stair case permanently blocks floor space and even when the area beneath the stairs is used for storage it is limited by its odd shape. The opening and rails for fixed stair cases also consume more upper level floor space than the opening required for a retractable stair. However, the retraceable stairs normally utilize large springs which exert more force than the moveable portion of the stair weighs which is necessary to assist the user to retract the stairs and hold them in the closed position. This presents a problem for some persons to generate enough pull-down force and these stairs usually have a pull cord which can be unsightly. Another problem can be ceiling height even though it can be accommodated by a longer pull cord that may be even more unsightly when the building design utilizes high ceilings for ascetic appeal and other attributes. The ceiling height may require a ladder to reach the stair sections to fold and unfold the sections.

### BRIEF SUMMARY OF THE INVENTION

The present invention is a power operated stair that may include power fold/unfolding of additional sections and security access. By providing mechanical power to the stair the present invention provides access to upper floors without the drawbacks of the force required to manipulate a spring loaded pull-down stair or an unaesthetic pull cord hanging down into the area below the stair. The utilization of electrical power enables the use of a control panel that provides access limitation by security code and can be operated remotely. The power operated stair may also include means for mechanically operating the stair in case of power or power unit failure. The invention also provides for isolation of the power cord to accommodate attachment to alternate power which would be very useful during construction or general power disruptions.

### BRIEF DESCRIPTION OF THE SEVERAL VIEWS OF THE DRAWING

FIG. 1 is a perspective view showing the power operated stairs in its extended state.

FIG. 2 is an end view of the power unit and aperture frame shown without chains to show the alignment of the sprockets.

FIG. 3 is a detail view of the hubs that pass through the aperture frame to transmit rotational force to the folding arms that raise and lower the stairs.

FIG. 4 is a front view of the control panel and mounting box showing the structure power disconnect feature.

### DETAILED DESCRIPTION OF THE INVENTION

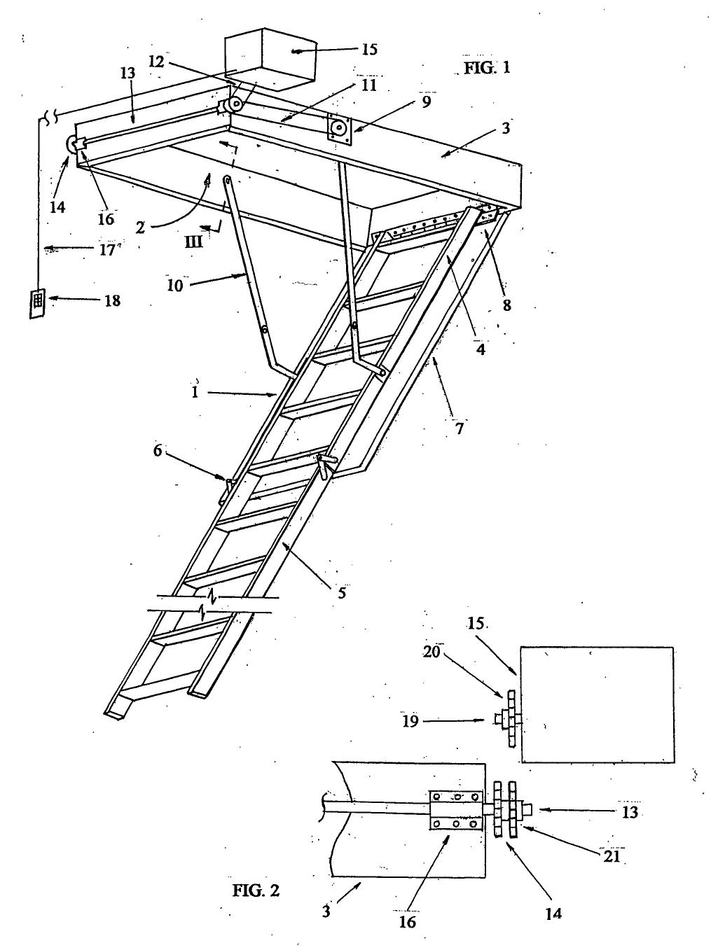

With reference to the drawings, the power stairs and power unit is illustrated in FIG. 1 in its extended position for access to the next upper floor.

As shown in FIG. 1, stair assembly 1 is mounted within a ceiling/floor aperture 2 by way of aperture frame 3. The stair assembly 1 includes basic stair section 4 and one or more stair extensions 5 having steps mounted between rails. The stair extensions 5 are joined to basic stair section 4 and together by joining hinges 6 to provide the foldable feature of the stair assembly 1. Basic stair section 4 is mounted on the upper surface of aperture cover 7. Base hinge 8 is attached to one end of aperture cover 7 and is further attached to one end of the of the aperture frame 3 allowing aperture cover 7 to move through an arc. Aperture hub 9 passes through aperture frame 3. Folding arms 10 attach to basic stair section 4 and aperture hub 9.

Power unit 15 is mounted to aperture frame 3 and the surrounding structure. Power unit 15 is connected to shaft 13 by way of drive chain 12. Shaft 13 is supported by shaft supports 16 and is connected to aperture hubs 9 by way of shaft sprockets 14 and driven chains 11. Power and command cable 17 connects power unit 15 to the structures power supply and control panel 18.

As shown in FIG. 2, power unit 15 has output shaft 19 on which output sprocket 20 is mounted. Drive chain 12 (FIG. 1) links output sprocket 20 to driven sprocket 21 which rotates shaft 13. Driven chain 11 (FIG. 1) connects shaft 13 to hubs 9. Shaft supports 16 attach and support shaft 13 to aperture frame 3.

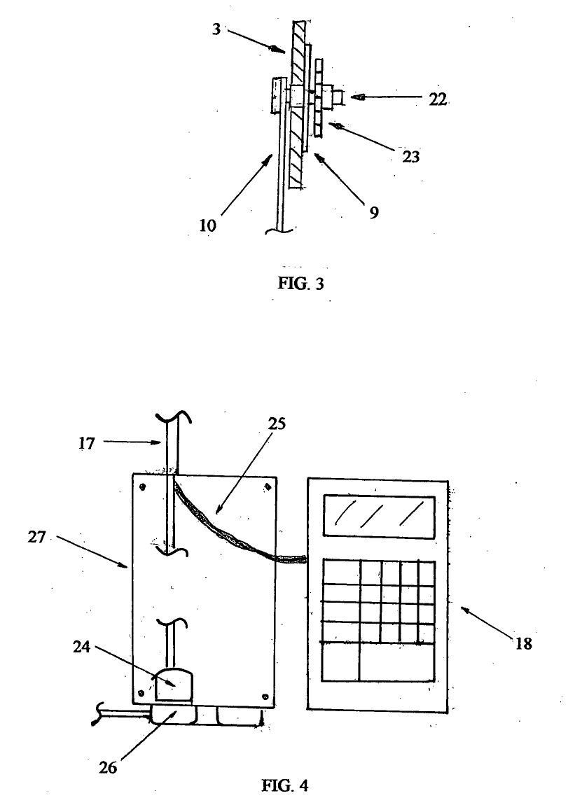

As shown in FIG. 3, hubs 9 pass through aperture frame 3. Folding arms 10 are rigidly attached to hub shafts 22 on which hub sprockets 23 are mounted. Hub sprockets 23 are connected to shaft 13 (FIG. 2) by way of driven chains 11 (FIG. 1) and shaft sprockets 14 (FIG. 1).

As shown in FIG. 4, power and command cable 17 divide into power cable 24 and command cable 25. Power cable 24 is connected to structure power supply by way of common receptacle 26. Control panel 17 serves as a cover for box 27. Power cable 24 may be isolated from structure power supply 26 by removing control panel 17 disconnecting and connecting it to an alternate power source.

I claim:

1. A power operated stair comprising: a stair assembly; aperture frame, power unit, means for transmitting mechanical power and control means;
said stair assembly comprising:
a basic stair section including an aperture frame and aperture cover mounted to said basic stair section and including means for pivotally mounting first end of said basic stair section to a side portion of said aperture frame such that said stair assembly is pivotally retractable into the aperture;
said power unit comprising: means to receive and convert energy to mechanical force and a rotating output shaft;
said means for transmitting mechanical power comprising: a plurality of shafts, shaft supports, hubs, sprockets, chains and levers connected between said power unit, said aperture frame and said stair assembly; and
said control means comprising: a panel for receiving commands to extend or retract said stair assembly, energy control means to activate and deactivate said mechanical power unit according to those commands and travel limit and unsafe condition detectors.

2. The basic stair section of claim 1, further comprising at least one stair section extension including means for pivotally mounting said stair section extension to adjoining stair section.

3. The basic stair section of claim 1, further comprising; at least one stair section extension including means for pivotally mounting said stair section extension to adjoining stair section. and section power moving means operably connected to adjoining stair section(s);

4. The power operated stair of claim 1, wherein said power unit and means for transmitting mechanical power comprise unitary synchronized jack screws.

5. The power operated stair of claim 1, wherein said power unit comprises a hydraulic power source and wherein means for transmitting mechanical power comprises lumens, control valves and cylinders.

6. The power operated stair of claim 1, wherein said power unit operates on ac or dc current.

7. The power operated stair of claim 1, wherein said power unit further comprised means for receiving external mechanical power.

8. The power operated stair of claim 1, wherein said control unit further comprises remote control

9. A power operated stair comprising: a stair assembly; aperture frame, power unit; means for transmitting mechanical power and control means;
said stair assembly comprising:
a basic stair section including an aperture frame, aperture cover mounted to said basic stair section and including means for pivotally mounting first end of said basic stair section to a side portion of an aperture frame such that said stair assembly is pivotally retraceable into the aperture and at least one stair section extension including means for pivotally mounting said stair section extension to second end of adjoining stair section;
said power unit comprising: means to receive and convert energy to mechanical force, a rotating output shaft and means to receive external mechanical power;
said means for transmitting mechanical power comprising: a plurality of shafts, shaft supports, hubs, sprockets, chains and levers connected between said mechanical power unit said aperture frame and said stair assembly; and
said control means comprising: a panel for receiving commands to extend or retract said stair assembly, energy control means to activate and deactivate power unit and section power moving means according to those commands, travel limit and unsafe condition detectors and remote control.

10. The power operated stair of claim 9, wherein said power unit and means for transmitting mechanical power comprise unitary synchronized electric jack screws.

11. The power operated stair of claim 9, wherein said mechanical power unit comprises a hydraulic power source and wherein means for transmitting mechanical power comprises lumens, control valves and cylinders.

12. The power operated stair of claim 9, wherein said mechanical power unit operates on ac or dc current.

13. The power operated stair of claim 9, wherein said stair extension(s) is slidably attached to adjoining stair section.

14. The power operated stair of claim 9, further comprising an alternate emergency power source.

15. The power operated stair of claim 9, wherein said basic stair section further comprises; section power moving means operably connected to adjoining stair section(s).
